(19) United States
(12) Patent Application Publication
(10) Pub. No.: US 2010/0271197 A1
(43) Pub. Date: Oct. 28, 2010

(54) Engine Start Warning System

(76) Inventor: Joao Carlos Almeida, N. Chelmsford, MA (US)

Correspondence Address: LAW OFFICES OF MICHAEL L. WISE, LLC, 260 WALSH RD., LAGRANGEVILLE, NY, 12540, US

(21) Appl. No.: 12/749,535

(22) Filed: Mar. 30, 2010

Related U.S. Application Data
(60) Provisional application No. 61/214,278, filed on Apr. 22, 2009.

(51) Int. Cl. H04Q 1/30

(52) U.S. Cl. 340/532

(57) ABSTRACT

An apparatus for a vehicle that has a propulsion mechanism capable of causing injury to a bystander located proximate to the propulsion mechanism when the propulsion mechanism is started comprises an activation switch, a speaker, and a sound controller. The activation switch is accessible to an operator of the vehicle. The sound controller is operative to cause the speaker to emit an audible warning in response to an activation of the activation switch prior to the propulsion mechanism being started.

### CROSS REFERENCES TO RELATED APPLICATIONS

This application claims the benefit of U.S. Provisional Application No. 61/214,278, filed Apr. 22, 2009.

### FIELD OF THE INVENTION

The present invention relates generally to vehicles used for transportation, and, more particularly, to apparatus for producing audible warnings from vehicles with hazardous propulsion mechanisms such as vehicles with propellers and jet engines.

### BACKGROUND OF THE INVENTION

Before electric engine starters for aircraft were prevalent, a pilot would typically start the engine of a propeller-driven airplane with assistance from a lineman. The lineman would turn the airplane's propeller by hand so that the engine could fire. In doing so, the lineman would also ensure that no people were standing within the arc of the propeller or within its hazardous intake and exhaust paths.

Nevertheless, since the widespread introduction of electric starters, such linemen are unnecessary for starting an aircraft's engine. Instead, the engine may be started by the pilot from inside the cockpit by simply turning a key or pushing a button. For this reason, pilots are instructed to verify themselves whether the area around the propeller is clear for engine start. Typically, pilots are taught to visually verify the area and at the same time shout the words “clear” or “clear prop” through the window in the cockpit as a warning.

This method, though widely used, presents several disadvantages. First, many pilots are incapable of yelling the warning with sufficient volume to have the warning effectively alert bystanders, especially in a noisy airport environment. Second, in most cases, the spoken warning only reaches the pilot's side of the aircraft. Third, many aircraft do not feature a window through which the pilot can issue the warning, thereby causing any spoken warning to be further muted. Lastly, a new generation of pilots accustomed to performing tasks by automation perceives the traditional method of shouting a warning as awkward and inefficient.

As a result of these problems, accidents involving humans and moving aircraft propellers continue to occur on a regular basis. The Aircraft Owners and Pilots Association (Frederick, Md., USA) reports that, for example, on average, two fatalities from such accidents occur every year.

For the foregoing reasons, there is a need for apparatus that allow operators of propeller-driven vehicles, and more generally, operators of any vehicle having a mode of propulsion that creates a localized hazard when running, to adequately warn bystanders that the engine is about to be started.

### SUMMARY OF THE INVENTION

Embodiments of the present invention address the above-identified need by providing an apparatus operative to emit a loud and easily-heard audio warning from vehicles with hazardous propulsion mechanisms prior to the propulsion mechanisms being started.

In accordance with an aspect of the invention, an apparatus for a vehicle that has a propulsion mechanism capable of causing injury to a bystander located proximate to the propulsion mechanism when the propulsion mechanism is started comprises an activation switch, a speaker, and a sound controller. The activation switch is accessible to an operator of the vehicle. The sound controller is operative to cause the speaker to emit an audible warning in response to an activation of the activation switch prior to the propulsion mechanism being started.

In accordance with one of the above-identified embodiments of the invention, a propeller-driven aircraft comprises an Engine Start Warning System (ESWS). The ESWS comprises an activation switch, a speaker, and a sound controller. Activation of the activation switch by the pilot prior to starting the engine causes the sound controller to emit a loud audible warning through the speaker. The audible warning comprises a combination of noises and words that warn bystanders to the aircraft to clear the area in the region of the propeller. Once the area is cleared in this way, the pilot is free to start the engine in a safe manner.

Advantageously, embodiments of the invention provide significant safety advantages to the operations of vehicles having hazardous propulsion mechanisms (e.g., propellers and jet engines).

### BRIEF DESCRIPTION OF THE DRAWINGS

These and other features, aspects, and advantages of the present invention will become better understood with regard to the following description, appended claims, and accompanying drawings where:

FIG. 1 shows a side perspective view of an aircraft in accordance with an illustrative embodiment of the invention with several components also shown in enlarged perspective views;

FIG. 2 shows a block diagram of an illustrative ESWS in the FIG. 1 aircraft embodiment;

FIG. 3 shows a flow diagram of an illustrative process for safely starting the engine of the FIG. 1 aircraft embodiment; and

FIG. 4 shows a side elevation view of a boat in accordance with an illustrative embodiment of the invention.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

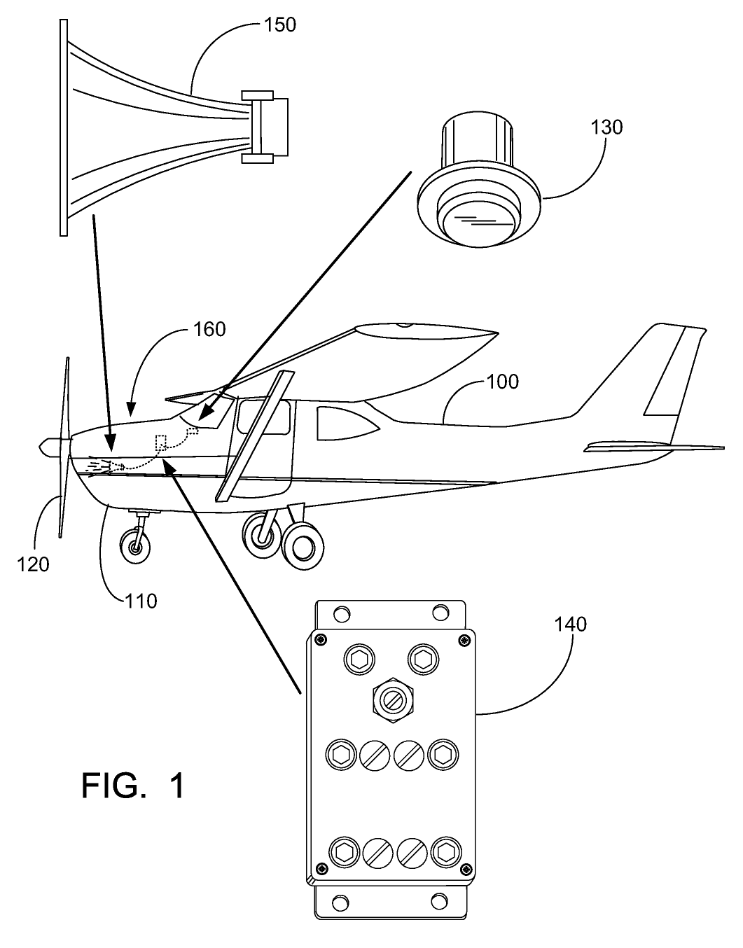

FIG. 1 shows a side perspective view of an aircraft 100 in accordance with a first illustrative embodiment of the invention. In the present embodiment, the aircraft resembles a single-engine airplane manufactured by Cesssna Aircraft Company (Wichita, Kans., USA), but this choice of aircraft is merely illustrative. The aircraft has all of the conventional features found on such an aircraft (e.g., airframe, flight controls, instrument panel, landing gear, seats, fuel system, brake system, electrical system, lighting system, avionics, etc.). An engine compartment 110 sits at the front of the aircraft. The engine compartment comprises an internal combustion engine (not explicitly shown) that turns a propeller 120. The turning propeller, in turn, acts as the aircraft's propulsion mechanism.

In addition to showing many of the conventional features of the aircraft 100, FIG. 1 also shows three novel elements unique to the present invention, namely, an activation switch 130, a sound controller 140, and a speaker 150. These three components collectively constitute an illustrative ESWS 160. The ESWS is integrated into the aircraft. The activation switch is disposed within the instrument panel of the aircraft so that it may be manually operated by the pilot while sitting in the vehicle. The sound controller is located forward of the instrument panel and to the rear of the engine firewall in the space normally reserved for avionics. Finally, the speaker resides near the front of the engine compartment 110 proximate to the propeller 120.

As indicated earlier, the propeller 120 of the aircraft 100 shown in FIG. 1 is capable of causing serious injury or death to a bystander standing proximate to the propeller when the propeller is started (i.e., when the engine is started). Such a hazard is especially prevalent when the engine is first started since a bystander may be unaware that the propeller is about to begin moving. A purpose of the ESWS 160 is therefore to warn bystanders to clear the hazardous areas around the propeller before the engine is started so that the engine start may be conducted in a safe manner.

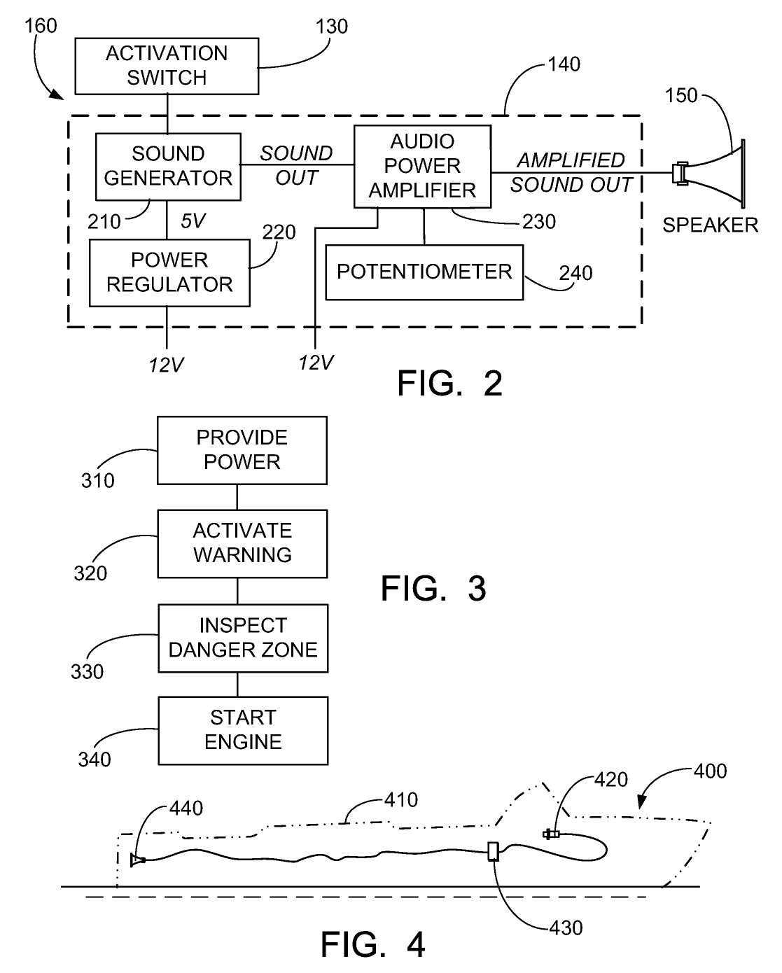

Further details of the ESWS 160 can be seen in the block diagram shown in FIG. 2. The sound controller 140 comprises a sound generator 210, a power regulator 220, an audio power amplifier 230, and a potentiometer 240. In this particular example, the sound controller is adapted to run off of the aircraft's electrical system. More particularly, the sound controller is adapted to be powered by the aircraft's twelve volt (V) battery, which is available as a source of power before the aircraft's engine is started.

The sound generator 210 may comprise any combination of analog, digital, or mixed-mode electronics operative to store and play back the sound pattern that will be utilized as the audible warning. Suitable sound generators are commercially available as integrated circuits that typically comprise various combinations of oscillators, envelope controllers, samplers, filters and amplifiers. The sound generator in the present embodiment may, as just one example, comprise an ISD1400 Single-Chip Voice Record/Playback Device available from Winbond Electronics Corporation (Hsin-Chu, Taiwan, R. O. C.), although any other device capable of storing and emitting an audible warning may be utilized and the results would still come within the scope of the invention. The audible warning may be recorded on the sound generator using a microphone and then played back, or, alternatively, may be programmed into the sound generator directly as digital data and then synthesized by the sound generator. In any case, it is preferred that the audible warning include an alarm sound (e.g., siren, horn, buzz, beep, whistle) in combination with the words “clear” or “clear prop.” Inclusion of these particular words is preferred because pilots are conventionally taught to use these words before starting their aircraft. Accordingly, these particular words have a special meaning to those people that may be found on an airport ramp; they warn such bystanders that a pilot is about to start an aircraft's engine.

In the particular embodiment shown in FIG. 2, the sound generator 210 (e.g., ISD1400) is powered by only five volts (i.e., Vcc=5 V). Accordingly, the power regulator 220 is utilized in the present embodiment to reduce the aircraft's 12 V power source down to the required sound generator supply voltage. Power regulators capable of making this reduction are commonplace. The power regulator may, as just one example among many, comprise an LM78L05 Series 3-Terminal Positive Regulator available from National Semiconductor Corporation (Santa Clara, Calif., USA).

The sound generator 210 is activated by the activation switch 130, which, as mentioned earlier, is available to the pilot in the cockpit. The activation switch is preferably a push-to-make, momentary-action push switch (single-pole-single-throw), but again, any alternative switch may be utilized. Such an activation switch is easily implemented on conventional sound generators such as the ISD1400. In the case of the ISD1400, one can, as an example, utilize the activation switch in association with the edge-activated playback pin, PLAYE, which activates playback when the pin is made to go LOW.

The audible warning will preferably be sufficiently loud to be heard by a bystander standing near to the speaker on a noisy airport ramp. The speaker 150 will, for example, preferably emit the sound warning with a sound intensity greater than about 80-90 decibels. In the present embodiment, the sound generator 210 is not adequate to produce this preferred sound intensity, so the audio power amplifier 230 is interposed between the sound generator and the speaker. The audio power amplifier may be, as just one example, a LM386 Low Voltage Audio Power Amplifier available from National Semiconductor Corporation, although any other suitable audio amplifier may also be utilized.

Advantageously, the addition of an external variable resistor to many conventional audio power amplifiers (including the LM386) allows their voltage gain to be varied. In the present case, the potentiometer 240 is connected to the audio power amplifier 230 to effectively act as a volume control. The potentiometer may be located directly on the case of the sound controller 140, or alternatively, may be located remotely on the instrument panel of the aircraft 100. The former configuration is easier to implement in an aircraft because the need for wiring is reduced. The latter configuration has the advantage of allowing the pilot to adjust the audible warning volume depending on the ambient noise conditions at the time the warning is made.

The speaker 150 may be any suitable type of speaker designed for “public address” use or the like. The speaker is preferably weatherproofed to handle exposure to the elements. Such speakers are available from a number of manufacturers including, as just one example, Speco Technologies (Amityville, N.Y., USA). Speaker impedance may be, for instance, eight ohms.

As indicated above, the ESWS 160, while novel and non-obvious, may be implemented using conventional, commercially-available electronic components. As a result, implementation of the ESWS would be well within the abilities of one of ordinary skill in the electronic arts. Moreover, there are several references that describe electronic design and can be used for reference in implementing the described functionality. One such reference is P. Horowitz and W. Hill, The Art of Electronics, Second Edition, Cambridge University Press, 1989, which is hereby incorporated by reference herein.

FIG. 3 goes on to show an illustrative process for starting the aircraft 100 utilizing the ESWS 160. When ready to start the engine, the pilot first configures the aircraft such that power is supplied to the sound controller 140, as indicated in step 310. The pilot, may, for example, switch on the aircraft's “master switch,” which typically connects the aircraft's battery to a power distribution bus. The pilot then pushes the activation switch 130 causing the ESWS to issue the audible warning, as indicated in step 320. The pilot may repeat the warning as the pilot deems prudent simply by activating the activation switch several times and may adjust the sound volume as necessary if such an adjustment is available to the pilot in the cockpit. Subsequently, the pilot carefully inspects the danger zone around the aircraft to confirm that no bystanders are in harm's way, as indicated in step 330. Lastly, in step 340, the pilot performs those tasks needed to actually start the engine (e.g., turning on the fuel supply, priming the engine, setting the mixture and throttle, turning on the engine magnetos, and activating the starter motor).

It should be noted that, while the above-described embodiment, illustrates a propeller driven aircraft, embodiments in accordance with aspects of the invention may be applied to any vehicle having a propulsion mechanism capable of causing injury to a bystander located proximate to the propulsion mechanism when the propulsion mechanism is started. Such vehicles may include, for example, boats as well as aircraft. While partaking in scuba diving and waterskiing activities, it is commonplace for people to be in the water dangerously close the propeller(s) of a boat. Like the propeller of an aircraft, the propeller of a boat can easily cause serious injury or death to someone that comes in contact with it. Therefore, the ability to effectively warn people in the water to remove themselves from the region proximate to a boat's propeller(s) is highly desirable and the present invention provides such a solution.

Moreover, embodiments of the present invention may be implemented in vehicles (including aircraft and boats) having propulsion mechanisms that do not comprise propellers. The propulsion mechanisms may comprise, as just one more example, jet engines. As utilized herein, the term “jet engine” includes any reaction engine that discharges a fast moving jet of fluid (e.g., water or air) to generate thrust. As result, the term includes, but is not limited to, waterjets, turbojets, turbofans, rockets, ramjets, pulse jets, and pump-jets.

Likewise, the terms “aircraft” and “boat” as used herein are meant to be interpreted broadly. The term “aircraft” encompasses any vehicle capable of being supported by air, while the term “boat” encompasses any vehicle capable of being supported by water.

FIG. 4 shows the implementation of an illustrative ESWS 400 in a power boat 410. Like the aircraft 100 described above, the ESWS 400 in its most basic form comprises an activation switch 420, a sound controller 430, and a speaker 440. The ESWS preferably runs off of the boat's battery. The speaker is located near the rear of the boat so that any audible warning emanating therefrom has the best chance of being heard by people located near the boat's propulsion mechanism.

In closing, it should again be emphasized that the above-described embodiments of the invention are intended to be illustrative only. Other embodiments can use different types and arrangements of elements for implementing the described functionality. These numerous alternative embodiments within the scope of the appended claims will be apparent to one skilled in the art.

Moreover, all the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

What is claimed is:

1. An apparatus for a vehicle that has a propulsion mechanism capable of causing injury to a bystander located proximate to the propulsion mechanism when the propulsion mechanism is started, the apparatus comprising:
an activation switch, the activation switch accessible to an operator of the vehicle;
a speaker; and
a sound controller, the sound controller operative to cause the speaker to emit an audible warning in response to an activation of the activation switch prior to the propulsion mechanism being started.

2. The apparatus of claim 1, wherein the vehicle comprises an aircraft.

3. The apparatus of claim 1, wherein the vehicle comprises a boat.

4. The apparatus of claim 1, wherein the propulsion mechanism comprises a propeller.

5. The apparatus of claim 1, wherein the propulsion mechanism comprises a jet engine.

6. The apparatus of claim 1, wherein a sound intensity of the audible warning can be manually controlled.

7. The apparatus of claim 1, wherein the audible warning comprises spoken words.

8. The apparatus of claim 1, wherein the sound controller comprises an integrated circuit operative to play back sound through a speaker.

9. The apparatus of claim 1, wherein the sound controller is operative to reproduce or synthesize spoken words.

10. The apparatus of claim 1, wherein the sound controller comprises an audio amplifier.

11. The apparatus of claim 1, wherein the activation switch comprises a push switch.

12. The apparatus of claim 1, wherein an operator in the vehicle can adjust a sound intensity of the audible warning.

13. The apparatus of claim 1, wherein the apparatus is powered by a power supply that also powers other components of the vehicle.

14. The apparatus of claim 1, wherein the sound controller comprises a power regulator.

15. A vehicle that has a propulsion mechanism capable of causing injury to a bystander located proximate to the propulsion mechanism when the propulsion mechanism is started, the vehicle having an apparatus comprising:
an activation switch, the activation switch accessible to an operator of the vehicle;
a speaker; and
a sound controller, the sound controller operative to cause the speaker to emit an audible warning in response to an activation of the activation switch prior to the propulsion mechanism being started.

16. The vehicle of claim 15, wherein the vehicle comprises an aircraft.

17. The vehicle of claim 15, wherein the vehicle comprises a boat.

18. The vehicle of claim 15, wherein the propulsion mechanism comprises a propeller.

19. The vehicle of claim 15, wherein the propulsion mechanism comprises a jet engine.
